(19) United States
(12) Patent Application Publication
(10) Pub. No.: US 2025/0173892 A1
(43) Pub. Date: May 29, 2025

(54) APPARATUS AND METHOD FOR IMAGE ANALYSIS

(71) Applicant: HANWHA VISION CO., LTD., Seongnam-si (KR)

(72) Inventors: Dong Jin PARK, Seongnam-si (KR); Dae Bong Kim, Seongnam-si (KR)

(73) Assignee: HANWHA VISION CO., LTD., Seongnam-si (KR)

(21) Appl. No.: 19/037,570

(22) Filed: Jan. 27, 2025

Related U.S. Application Data
(63) Continuation of application No. PCT/KR2023/006885, filed on May 22, 2023.

(30) Foreign Application Priority Data
Sep. 20, 2022 (KR) 10-2022-0118655
May 15, 2023 (KR) 10-2023-0062399

(51) Int. Cl. G06T 7/70; G06T 7/50

(52) U.S. Cl. CPC G06T 7/70; G06T 7/50

(57) ABSTRACT

Provided are an apparatus and a method for image analysis for obtaining an absolute distance of each pixel for an entirety of a depth map. The apparatus for image analysis includes: an imaging unit configured to generate a captured image; an object detection unit configured to detect at least one object from the captured image; a depth map generation unit configured to generate a depth map for the captured image; and a map analysis unit configured to obtain an absolute distance of each pixel for an entire area of the depth map by selecting a standard object among the detected at least one object and referring to an absolute distance obtained for a standard map object corresponding to the standard object among map objects included in the depth map.

### CROSS-REFERENCE TO RELATED APPLICATION(S)

This application is a bypass Continuation Application of International Application No. PCT/KR2023/006885 filed on May 22, 2023, which claims priority from Korean Patent Application Nos. 10-2022-0118655 filed on Sep. 20, 2022, and 10-2023-0062399 filed on May 15, 2023, in the Korean Intellectual Property Office, the disclosures of which are incorporated herein in their entireties by reference.

### BACKGROUND

One or more example embodiments of the disclosure relate to an apparatus and a method for image analysis, and more particularly to, an apparatus and a method for image analysis for obtaining an absolute distance for an entirety of a depth map by obtaining an absolute distance of a standard map object among map objects included in the depth map and applying the absolute distance to a remaining portion of the depth map.

A depth map represents information that includes a distance between an observation point and an object. Since the depth map includes distance information between the observation point and each surface of the object, it is possible to obtain a three-dimensional image of the object using the depth map.

On the other hand, since the depth map includes only information on a relative distance between the observation point and the object, an absolute distance of the object from the observation point included in the depth map may not be obtained through the depth map.

Therefore, there is a need for a method that may obtain the absolute distance of the object included in the depth map.

### SUMMARY

One or more example embodiments of the disclosure provide an apparatus and a method for image analysis that may obtain an absolute distance of an object for an entirety of a depth map by obtaining an absolute distance of a standard map object among map objects included in the depth map and applying the obtained absolute distance to a remaining portion of the depth map.

Aspects of the disclosure are not limited to the above-mentioned aspects. That is, other aspects that are not mentioned may be obviously understood by those skilled in the art from the following specification.

According to an aspect of an example embodiment of the disclosure, there is provided an apparatus for image analysis, including at least one memory configured to store program code; and at least one processor configured to execute the program code to implement: an imaging unit configured to generate a captured image; an object detection unit configured to detect at least one object from the captured image; a depth map generation unit configured to generate a depth map for the captured image; and a map analysis unit configured to obtain an absolute distance of each pixel for an entire area of the depth map by selecting a standard object among the detected at least one object and referring to an absolute distance obtained for a standard map object corresponding to the standard object among map objects included in the depth map.

The depth map may include information on a relative distance of the at least one object included in the captured image.

The object detection unit may be configured to, in detecting the at least one object, detect at least one reference object for which standard size information is secured among the at least one object included in the captured image, and select the standard object among the detected at least one reference object.

The standard map object may include at least two standard map objects, and the map analysis unit may include: a distance obtaining unit configured to obtain an absolute distance of each of the at least two standard map objects by referring to a size of each of the at least two standard map objects; and a distance conversion unit configured to convert a relative distance of each pixel for the entire area of the depth map into an absolute distance according to a ratio between a relative distance and the absolute distance of each of the at least two standard map objects.

The distance obtaining unit may be configured to obtain the absolute distance of each of the at least two standard map objects by referring to a size of a standard area included in a preset portion of each of the at least two standard map objects.

The distance obtaining unit may be configured to obtain the relative distance of each of the at least two standard map objects by extracting relative distance information of two or more pixels included in the standard area.

The distance obtaining unit may be configured to: generate a feature area of a preset size in the standard area, and determine an average value or a median value of relative distances of the two or more pixels included in the feature area as the relative distance of each of the at least two standard map objects.

The map analysis unit may be configured to: detect a standard object from a captured image for a pre-set area of interest of a capturable area of the imaging unit, and update an absolute distance previously obtained for a depth map of a previously captured image, based on the detected standard object.

The capturable area may include a plurality of areas of interest, and the map analysis unit may be configured to detect a standard object from a captured image for an area of interest, which is selected in a preset order among the plurality of areas of interest.

The object detection unit may be configured to detect the at least one object in real time from the captured image, and the map analysis unit may be configured to, based on detecting the at least one object in real time, obtain the absolute distance of each pixel for the entire area of the depth map.

According to an aspect of an example embodiment of the disclosure, there is provided a method for image analysis, the method being executed by at least one processor and including: generating a captured image; detecting at least one object from the captured image; generating a depth map for the captured image; selecting a standard object among the detected at least one object; and obtaining an absolute distance of each pixel for an entire area of the depth map by referring to an absolute distance obtained for a standard map object corresponding to the standard object among map objects included in the depth map.

The depth map may include information on a relative distance of the at least one object included in the captured image.

The detecting the object may include detecting at least one reference object for which standard size information is secured among the at least one object included in the captured image, and selecting the standard object among the detected at least one reference object.

The standard map object may include at least two standard map objects, and the obtaining the absolute distance of each pixel for the entire area of the depth map may include: obtaining an absolute distance of each of the at least two standard map objects by referring to a size of each of the at least two standard map objects; and converting a relative distance of each pixel for the entire area of the depth map into an absolute distance according to a ratio between a relative distance and the absolute distance of each of at least two standard map objects.

The obtaining the absolute distance of each of the at least two standard map objects may include obtaining the absolute distance of each of the at least two standard map objects by referring to a size of a standard area included in a preset portion of each of the at least two standard map objects.

The method may further include obtaining a relative distance of each of the at least two standard map objects by extracting relative distance information of two or more pixels included in the standard area.

The obtaining the relative distance of each of the at least two standard map objects may include: generating a feature area of a preset size in the standard area; and determining an average value or a median value of relative distances of the two or more pixels included in the feature area as the relative distance of each of the at least two standard map objects.

The method may further include: detecting a standard object from a captured image for a pre-set area of interest of a capturable area of an imaging unit configured to generate the captured image; and updating an absolute distance previously obtained for a depth map of a previously captured image, based on the detected standard object.

The capturable area may include a plurality of areas of interest, and the detecting the standard object may include detecting the standard object from a captured image for an area of interest, which is selected in a preset order among the plurality of areas of interest.

The detecting the at least one object from the captured image may include detecting the at least one object in real time from the captured image, and the obtaining the absolute distance of each pixel for the entire area of the depth map may include obtaining the absolute distance of each pixel for the entire area of the depth map, based on detecting the at least one object in real time.

The details of other embodiments are included in the detailed description and drawings.

### BRIEF DESCRIPTION OF DRAWINGS

Example embodiments will be more clearly understood from the following detailed description taken in conjunction with the accompanying drawings.

FIG. 1 is a block diagram of an apparatus for image analysis according to an embodiment of the disclosure;

FIG. 2 is a block diagram of a map analysis unit according to an embodiment of the disclosure;

FIG. 3 is a diagram illustrating a captured image according to an embodiment of the disclosure;

FIG. 4 is a diagram illustrating a reference object being detected from a captured image according to an embodiment of the disclosure;

FIG. 5 is a diagram illustrating a depth map of a captured image according to an embodiment of the disclosure;

FIG. 6 is a diagram illustrating a standard box formed in a portion of a reference map object according to an embodiment of the disclosure;

FIG. 7 is a diagram illustrating a standard area formed in a standard box according to an embodiment of the disclosure;

FIG. 8 is a diagram illustrating a standard box formed in an entirety of a standard map object according to an embodiment of the disclosure;

FIG. 9 is a diagram illustrating standard points displayed on a distance coordinate plane according to an embodiment of the disclosure;

FIG. 10 is a diagram illustrating that a standard graph is formed based on standard points according to an embodiment of the disclosure;

FIG. 11 is a diagram illustrating that a standard graph is formed based on three standard points according to an embodiment of the disclosure;

FIG. 12 is a flowchart illustrating a method for image analysis according to an embodiment of the disclosure; and

FIG. 13 is a diagram illustrating that a region of interest is switched according to an embodiment of the disclosure.

### DETAILED DESCRIPTION

Hereinafter, one or more example embodiments of the disclosure will be described in detail with reference to the accompanying drawings. Advantages and features of the disclosure, and a method for achieving the advantages and features will become apparent with reference to the example embodiments described below in detail in conjunction with the accompanying drawings. However, the disclosure is not limited to the embodiments disclosed below, but may be implemented in a variety of different forms, these embodiments will be provided only in order to make the disclosure complete and allow those skilled in the art to completely recognize the scope of the disclosure, and the disclosure is only defined by the scope of the claims. The same reference numbers indicate the same components throughout the specification.

Unless defined otherwise, all terms (including technical and scientific terms) used in the present specification have the same meaning as meanings commonly understood by those skilled in the art to which the disclosure pertains. In addition, terms defined in generally used dictionaries are not ideally or excessively interpreted unless specifically defined clearly.

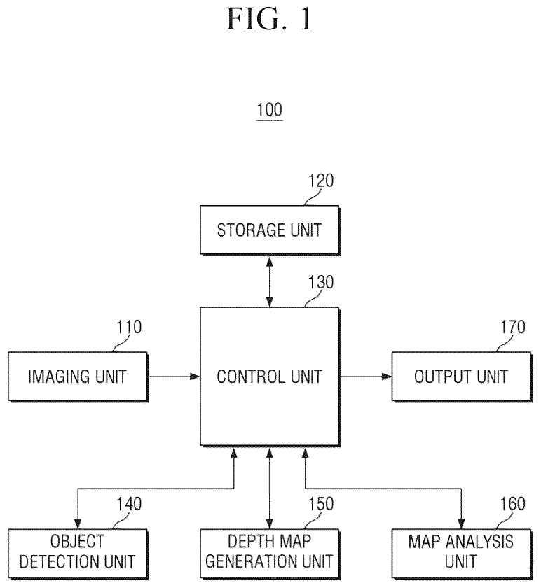

FIG. 1 is a block diagram of an apparatus for image analysis according to an embodiment of the disclosure.

Referring to FIG. 1, an apparatus 100 for analyzing an image according to an embodiment of the disclosure may include an imaging unit 110, a storage unit 120, a control unit 130, an object detection unit 140, a depth map generation unit 150, a map analysis unit 160, and an output unit 170.

The imaging unit 110 may generate a captured image. For example, the imaging unit 110 may include a camera equipped with an image sensor such as a complementary metal-oxide-semiconductor (CMOS) or a charge-coupled device (CCD).

In the disclosure, the imaging unit 110 may include a monocular camera. The captured image generated by the imaging unit 110 may represent an image captured at one capturing point.

In addition, the imaging unit 110 may be equipped with a lens unit (not illustrated) capable of performing auto focus. The imaging unit 110 may perform auto focus under the control of the map analysis unit 150.

In addition, the imaging unit 110 may be capable of adjusting a capturing direction. For example, the imaging unit 110 may include a pan tilt equipment (not illustrated). The pan tilt equipment may adjust the capturing direction of the imaging unit 110 according to an input control signal.

The storage unit 120 may temporarily or permanently store the captured image generated by the imaging unit 110. In addition, the storage unit 120 may store a depth map generated by the depth map generation unit 150 and may also store an analysis result generated by the map analysis unit 160.

In addition, the storage unit 120 may include a table (hereinafter, referred to as an absolute distance table) (not illustrated) that includes a correlation between a size and an absolute distance of an object from the imaging unit 110. In general, people, bicycles, and vehicles may be formed in a certain size. In this way, when an object whose size is generally uniform is included in the captured image, an absolute distance of the object included in a depth map may be determined using the size of the object. The storage unit 120 may store an absolute distance table including the relationship between the size and the absolute distance of the object, which may be used by a distance obtaining unit described below.

The object detection unit 140 may detect an object from the captured image. To this end, the object detection unit 140 may use an object detection model. For example, the object detection unit 140 may detect an object from the captured image using YOLO (You Only Live Once) algorithm as the object detection model. The YOLO algorithm, which is relatively fast at detecting objects from the captured image, is an artificial intelligence algorithm suitable for surveillance cameras that process a real-time moving image. The result output from the YOLO algorithm may include a bounding box indicating a position of each object and a classification probability for what class that object belongs to.

The depth map generation unit 150 may generate a depth map for the captured image generated by the imaging unit 110. For example, the depth map generation unit 150 may generate the depth map of the captured image generated by the imaging unit 110, which may be the monocular camera, by using a deep learning-based model.

The depth map may include information on a relative distance of an object included in the captured image. The depth map may include the relative distance information between the objects included in the image, as well as relative distance information across surfaces that constitute each of the objects. For example, the depth map may be understood as including relative distance information for all pixels included in the captured image. By using the relative distance information of the objects, it is possible to estimate not only an arrangement relationship between the objects but also a three-dimensional shape of each object.

Alternatively, according to some embodiments of the disclosure, the depth map generation unit 140 may generate a depth map using an artificial intelligence model and then convert the depth map by reflecting characteristics of a focus lens (not illustrated) equipped in the imaging unit 110. More specifically, an absolute distance between the object captured by the imaging unit 110 and the imaging unit 110 may be obtained by referring to a position of the focus lens. In this case, the depth map generation unit 140 may convert the depth map such that an amount of a change of the absolute distance of the object with respect to the position of the focus lens is reflected in the converted depth map.

In addition, the depth map generation unit 140 may generate a depth map using at least one artificial intelligence model selected from among a plurality of different artificial intelligence models. The plurality of artificial intelligence models may generate optimal depth maps in different situations. For example, a first artificial intelligence model may generate an optimal depth map for an image including a daytime scene, and a second artificial intelligence model may generate an optimal depth map for an image including a nighttime scene. Additionally or alternatively, a third artificial intelligence model may generate an optimal depth map for an image including people or animals, and a fourth artificial intelligence model may generate an optimal depth map for an image including natural environments. The depth map generation unit 140 may select at least one of the plurality of artificial intelligence models by referring to capturing conditions by the imaging unit 110 and generate a depth map using the selected artificial intelligence model.

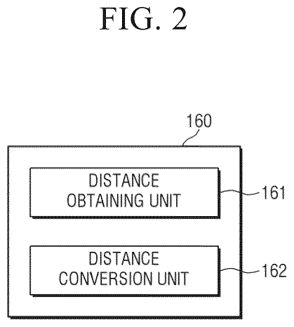

The map analysis unit 160 serves to analyze the depth map and obtain an absolute distance of an object for an entire area of the depth map. Specifically, the map analysis unit 160 may obtain the absolute distance for the entire area of the depth map by selecting a standard object among the objects detected by the object detection unit 140 and referring to an absolute distance obtained for a standard map object corresponding to the standard object among the map objects included in the depth map. The detailed configuration and function of the map analysis unit 160 will be described later with reference to FIGS. 2 to 8.

The output unit 170 may output an analysis result of the map analysis unit 160. A user may check the absolute distance for the entire area of the captured image by referring to the analysis result of the map analysis unit 160. In this case, based on the captured image generated without performing direction switching and enlargement by the imaging unit 110, the object detection unit 140 may detect the object, and the depth map generation unit 150 may generate the depth map. As a result, according to the disclosure, it is possible to output the analysis results by the map analysis unit 160 without switching the captured image being displayed.

The control unit 130 may perform overall control of the imaging unit 110, the storage unit 120, the object detection unit 140, the depth map generation unit 150, the map analysis unit 160, and the output unit 170. For example, when a user command for obtaining the absolute distance is input, the control unit 130 may control the imaging unit 110, the object detection unit 140, the depth map generation unit 150, and the map analysis unit 160 to generate the absolute distance of the depth map for the captured image.

Meanwhile, according to some embodiments of the disclosure, the control unit 130 may also control to generate the absolute distance of the depth map for the captured image without receiving the user command. In this case, the object detection unit 140 may detect an object in real time from the captured image. As a result, when the object is detected from the captured image based on the real-time detection result of the object detection unit 140, the map analysis unit 160 may obtain the absolute distance for the entire area of the depth map. When a new absolute distance is obtained, the map analysis unit 160 may update a previously generated absolute distance with the new absolute distance, and such a process may be repeatedly performed.

FIG. 2 is a block diagram of a map analysis unit according to an embodiment of the disclosure.

Referring to FIG. 2, the map analysis unit 160 may include a distance obtaining unit 161 and a distance conversion unit 162.

The distance obtaining unit 161 may obtain the absolute distance of the reference map object by referring to the size of the standard map object. As described above, the absolute distance table may be stored in the storage unit 120. The distance obtaining unit 161 may obtain the absolute distance of the standard map object by referring to the absolute distance table. The distance obtaining unit 161 may obtain the absolute distance of the standard map object by extracting the absolute distance corresponding to the size of the standard map object from the absolute distance table.

In the disclosure, the standard object may represent an object used to convert a relative distance for the entire area of the depth map into an absolute distance. The standard object may be randomly selected among the objects included in the captured image.

The distance conversion unit 162 may convert the relative distance for the entire area of the depth map into the absolute distance according to a ratio of the relative distance and the absolute distance of at least two standard map objects. When the relative and absolute distances for two or more standard map objects are confirmed, the ratio between the relative and absolute distances for the entirety (or entire area or entire pixels) of the depth map may be obtained through such confirmation. The distance conversion unit 162 may obtain the absolute distance of each area by applying the relative distance of the entire area constituting the depth map to the ratio between the relative distance and the absolute distance.

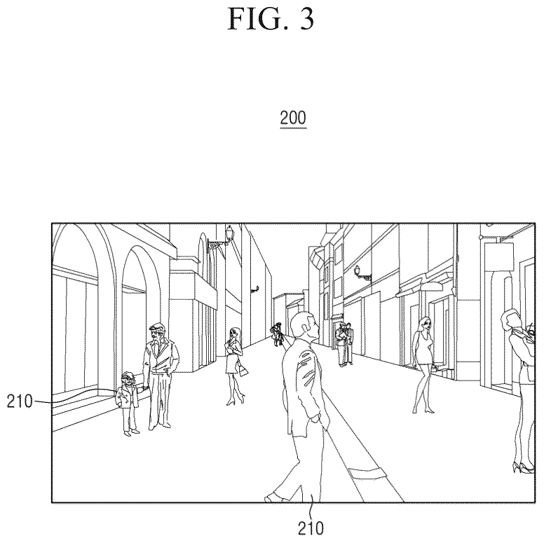

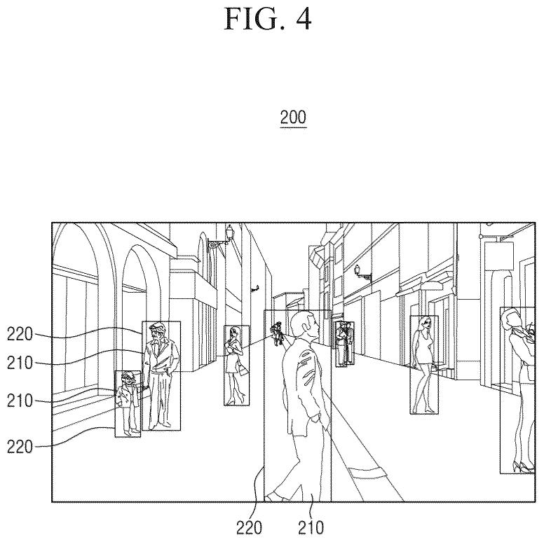

FIG. 3 is a diagram illustrating a captured image according to an embodiment of the disclosure and FIG. 4 is a diagram illustrating a reference object being detected from the captured image according to an embodiment of the disclosure.

Referring to FIG. 3, the imaging unit 110 may capture the front and generate a captured image 200.

The captured image 200 may include at least one object 210. The object 210 may include people, animals, vehicles, or buildings. The captured image 200, which is generated by the imaging unit 110, may be a still image or one of a plurality of scenes included in a moving image.

Referring to FIG. 4, the object detection unit 140 may detect the object 210 included in the captured image 200.

In particular, the object detection unit 140 of the apparatus 100 for image analysis according to the embodiment of the disclosure may detect a reference object. In the disclosure, the reference object refers to an object 210 included in the captured image 200 for which standard size information has been secured (or known). The people, bicycles, and vehicles may be formed in a certain size. In this way, an object whose size is generally uniformly formed may be the reference object, and the object detection unit 140 may detect such a reference object from the captured image 200. When the reference object is detected, a bounding box 220 may be formed around an edge of the reference object 210. The map analysis unit 160 described above may select a standard object among the reference objects.

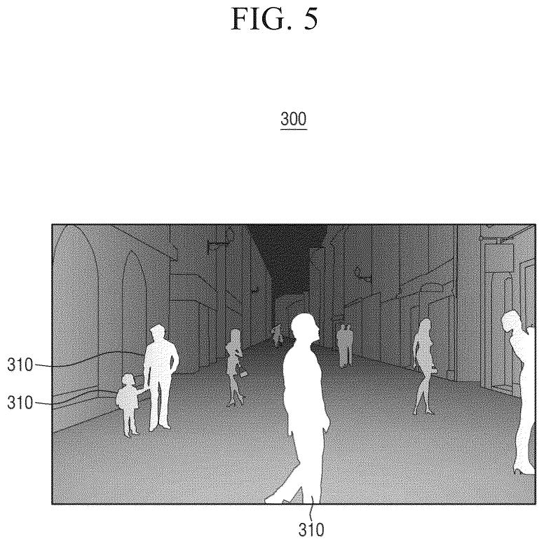

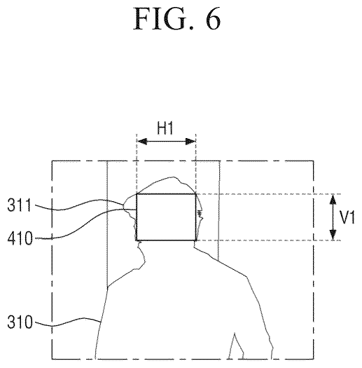

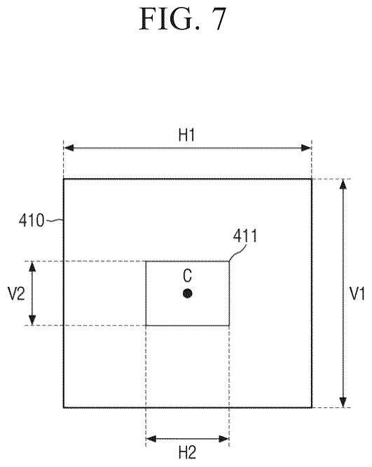

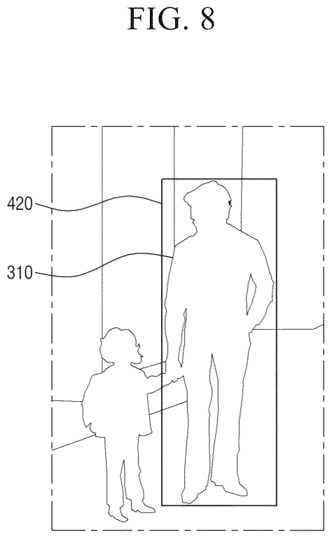

FIG. 5 is a diagram illustrating a depth map of the captured image according to an embodiment of the disclosure, FIG. 6 is a diagram illustrating a standard box formed in a portion of a reference map object according to an embodiment of the disclosure, FIG. 7 is a diagram illustrating a standard area formed in the standard box according to an embodiment of the disclosure, and FIG. 8 is a diagram illustrating a standard box formed in an entirety of the standard map object according to an embodiment of the disclosure.

Referring to FIG. 5, the depth map generation unit 150 may generate a depth map 300 for the captured image 200 of FIG. 4.

The depth map 300 may include relative distance information of an object 310. The relative distance information may represent a value determined for relatively distance between each point included in the depth map 300 and a capturing point.

In the disclosure, a resolution of the depth map 300 that may be processed by the map analysis unit 150 may be different from a resolution of the captured image 200. In this case, the depth map generation unit 140 may convert the resolution of the captured image 200 to correspond to a preset resolution of the depth map 300, and may generate the depth map 300 using the captured image having the converted resolution.

Referring to FIGS. 5 and 6, the distance obtaining unit 161 may extract a standard map object 310 corresponding to the standard object, and generate a standard area 410 in the standard map object 310.

The distance obtaining unit 161 may obtain an absolute distance of the standard map object 310 by referring to the size of the standard area 410 included in a pre-set portion 311 of the standard map object 310. For example, when the standard object is a person, the distance obtaining unit 161 may generate the standard area 410 in a portion (hereinafter, referred to as a target object) 311 of the standard map object 310 corresponding to a head of the person.

The standard area 410 may be provided in a form of a rectangle having a maximum size included in the target object 311. For example, four corners of the standard area 410 may overlap a boundary of the target object 311.

As the standard area 410 is provided in the form of a rectangle, the size of the standard area 410 may be obtained using a horizontal length H1 and a vertical length V1 of the standard area 410. The distance obtaining unit 161 may obtain the absolute distance of the standard map object by referring to the size of the standard area 410.

Referring to FIG. 7, the distance obtaining unit 161 may obtain a relative distance of the standard map object 310 by extracting some of relative distance information included in the standard area 410.

The distance obtaining unit 161 may generate a feature area 411 within the standard area 410. The distance obtaining unit 161 may generate the feature area 411 having a preset size. For example, the distance obtaining unit 161 may set a horizontal length H2 and a vertical length V2 of the feature area 411 to correspond to 30% of the horizontal length H1 and the vertical length V1 of the standard area 410, respectively.

The distance obtaining unit 161 may generate the feature area 411 at a center C of the standard area 410. For example, the distance obtaining unit 161 may generate the feature area 411 such that the center C of the standard area 410 matches with a center of the feature area 411. Meanwhile, according to some embodiments of the disclosure, the distance obtaining unit 161 may also generate the feature area 411 such that the feature area 411 is disposed at an arbitrary point in the standard area 410.

The distance obtaining unit 161 may obtain an average value or a median value of the relative distance included in the feature area 411 and determine the average value or the median value as the relative distance of the standard map object 310. Here, the average value represents a value obtained by dividing a sum of all relative distances of pixels included in the feature area 411 by a number of relative distances, and the median value represents a value corresponding to a middle of a distribution of the relative distances included in the feature area 411. Alternatively, the median value may represent a relative distance of a center pixel of the feature area 411. However, in the disclosure, this is only an example that the relative distance of the standard map object 310 is determined as the average or median value of the relative distances of pixels included in the feature area 411, and various values representing the corresponding feature area 411 may be determined as the relative distance of the standard map object 310. Hereinafter, it will be mainly described that the relative distance of the standard map object 310 is determined as the average or median value of the feature area 411.

The absolute distance and the relative distance of the standard map object 310 may be obtained by the distance obtaining unit 161, and the distance conversion unit 162 may convert the relative distance for the entire area of the depth map into an absolute distance based on the obtained absolute and relative distances.

Meanwhile, FIGS. 6 and 7 describe that the standard area 410 is generated in the target object 311, which is a portion of the standard map object 310, but as illustrated in FIG. 8, a standard area 420 may also be generated along an edge of the standard map object 310. In this case, the standard area 420 may be generated with the same size as the bounding box 220 of the standard object, and the distance conversion unit 162 may obtain the absolute distance and the relative distance of the standard map object 310 based on the standard area 420 generated with the same size as the bounding box 220 of the standard object.

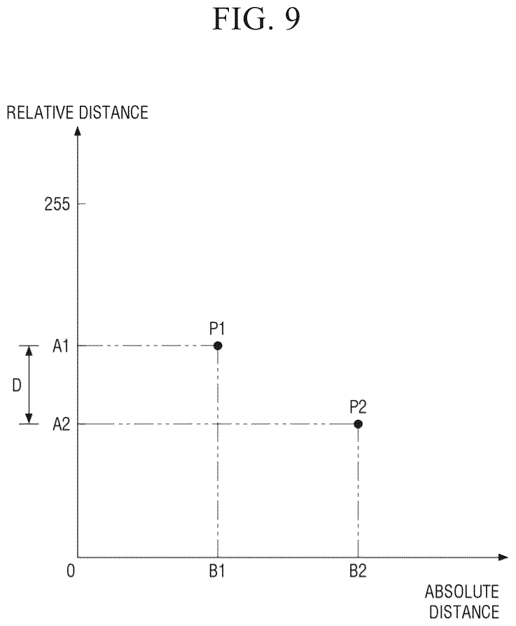

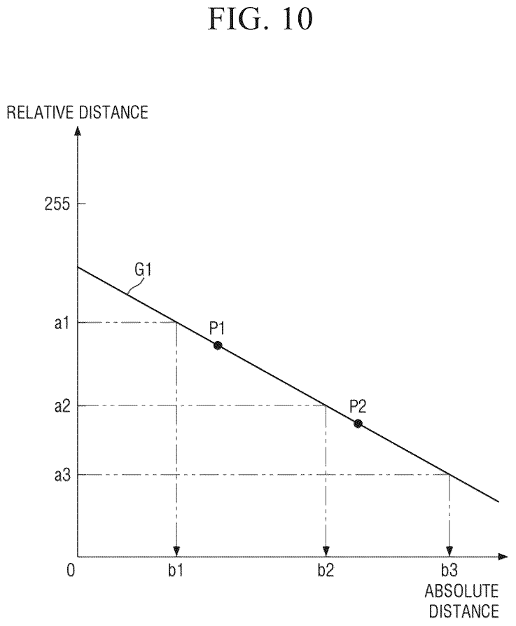

FIG. 9 is a diagram illustrating reference points displayed on a distance coordinate plane according to an embodiment of the disclosure and FIG. 10 is a diagram illustrating that a reference graph is formed based on the reference points according to an embodiment of the disclosure.

Referring to FIG. 9, the distance obtaining unit 161 may display standard points P1 and P2 on a distance coordinate plane.

The distance coordinate plane may be formed by a horizontal axis representing an absolute distance and a vertical axis representing a relative distance. The standard points P1 and P2 represent coordinate points on the distance coordinate plane corresponding to the standard map object 310.

The distance obtaining unit 161 may select a standard object among the reference objects. At least two standard objects may be selected from different reference objects.

In addition, the distance obtaining unit 161 may select a standard object such that a relative distance between different standard map objects 310 is formed to be a preset interval or more. FIG. 9 illustrates that a relative distance interval between two standard map objects 310 is D.

When the standard object is selected, the distance obtaining unit 161 may obtain the absolute distance of the standard map object 310 by generating the standard area 410 in the standard map object 310 corresponding to the standard object and referring to the size of the standard area 410. In addition, the distance obtaining unit 161 may obtain the relative distance of the standard map object 310 by forming the feature area 411 in the standard area 410 and referring to the relative distance of pixels included in the feature area 411. In this case, when the interval between the relative distances of different standard map objects 310 is less than a preset interval, the distance obtaining unit 161 may select a new standard object and repeat the above-described process based on the new standard object.

When the relative distance and the absolute distance of the standard map object 310 are confirmed, the standard points P1 and P2 corresponding to the standard object may be displayed on the distance coordinate plane. FIG. 9 illustrates two standard points P1 and P2 for two standard objects displayed on the distance coordinate plane. As a relative distance and an absolute distance of a first standard map object are A1 and B1, respectively, a first standard point P1 may be displayed on the distance coordinate plane based on the relative distance and the absolute distance of the first standard map object. Similarly, as a relative distance and an absolute distance of the second standard map object are A2 and B2, respectively, a second reference point P2 may be displayed on the distance coordinate plane based on the relative distance and the absolute distance of the second standard map object.

Referring to FIG. 10, the distance conversion unit 162 may generate a standard graph G1 based on the standard points P1 and P2.

The standard graph G1 may be generated by connecting a plurality of standard points P1 and P2. FIG. 10 illustrates that a standard graph G1, which is a straight line, is generated by connecting two standard points P1 and P2.

The standard graph G1 reflects the ratio of the absolute distance and the relative distance of the standard map object 310, and the distance conversion unit 162 may obtain an absolute distance for another portion of the depth map by using the standard graph G1. Referring to FIG. 10, when a relative distance of a corresponding point of the depth map is a1, an absolute distance of the corresponding point may be determined as b1 using the standard graph G1, when a relative distance of a corresponding point of the depth map is a2, an absolute distance of the corresponding point may be determined as b2 using the standard graph G1, and when a relative distance of a corresponding point of the depth map is a3, an absolute distance of the corresponding point may be determined as b3 using the standard graph G1.

Through such a process, the distance conversion unit 162 may obtain the absolute distances of the entire area of the depth map 300.

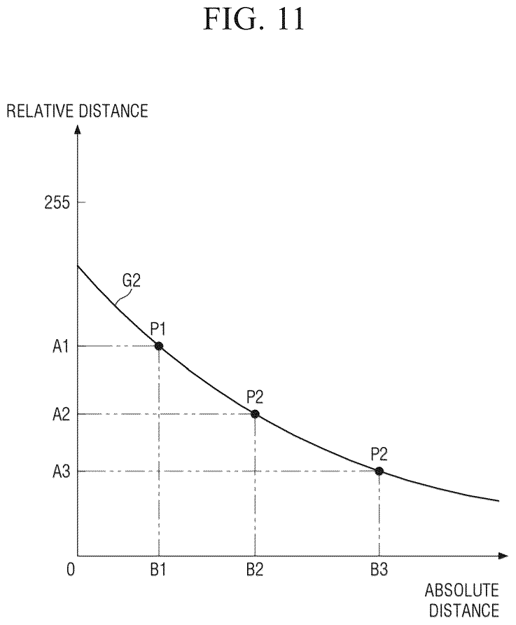

FIG. 11 is a diagram illustrating that a standard graph is formed based on three standard points according to an embodiment of the disclosure.

Referring to FIG. 11, the distance obtaining unit 161 may select three or more standard objects.

When there are three standard objects, three standard points P1, P2, and P3 may be displayed on the distance coordinate plane, and a standard graph G2 generated based on the three standard points P1, P2, and P3 may be formed as a curved line rather than a straight line.

As a relative distance and an absolute distance of a first standard object are A1 and B1, respectively, a first standard point PI may be displayed on the distance coordinate plane based on the relative distance A1 and the absolute distance B1 of the first standard object. As a relative distance and an absolute distance of a second standard object are A2 and B2, respectively, a second standard point P2 may be displayed on the distance coordinate plane based on the relative distance A2 and the absolute distance B2 of the second standard object. As a relative distance and an absolute distance of a third standard object are A3 and B3, respectively, a third standard point P3 may be displayed on the distance coordinate plane based on the relative distance A3 and the absolute distance B3 of the third standard object.

As the number of standard objects increases, the standard graph may be generated by reflecting the ratio of relative distances and absolute distances for a larger number of standard map objects corresponding to the standard objects. When the distance conversion is performed using the standard graph G2 generated based on the increased number of standard map objects, the reliability of distance conversion may be improved.

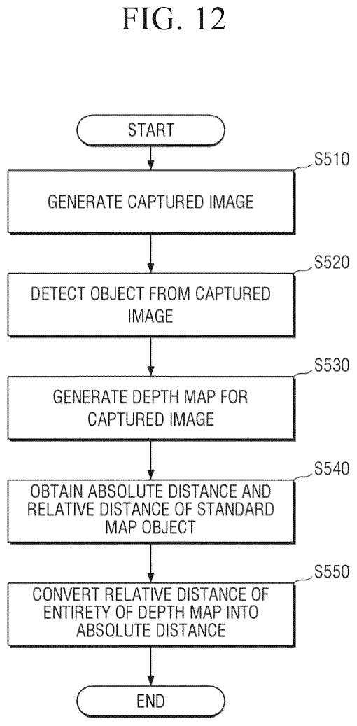

FIG. 12 is a flowchart illustrating a method for image analysis according to an embodiment of the disclosure.

Referring to FIG. 12, in order to obtain an absolute distance of the captured image 200 of the imaging unit 110, which may include a monocular camera, the imaging unit 110 may first generate the captured image 200 (S510).

The object detection unit 140 may detect an object from the captured image 200 (S520). Specifically, the object detection unit 140 may detect a reference object for which standard size information is secured among the objects included in the captured image 200.

The depth map generation unit 150 may generate a depth map for the captured image 200 (S530). The distance obtaining unit 161 of the map analysis unit 160 may select a standard object among the reference objects detected by the object detection unit 140. In addition, the distance obtaining unit 161 may obtain an absolute distance of the standard map object 310 by using the size of the standard map object 310 corresponding to the standard object (S540), and may obtain a relative distance of the standard map object 310 by generating the standard area 410 in the standard map object 310.

The distance conversion unit 162 may convert the relative distance for the entire area of the depth map into the absolute distance according to the ratio of the relative distance and the absolute distance of at least two standard map objects 310 (S550).

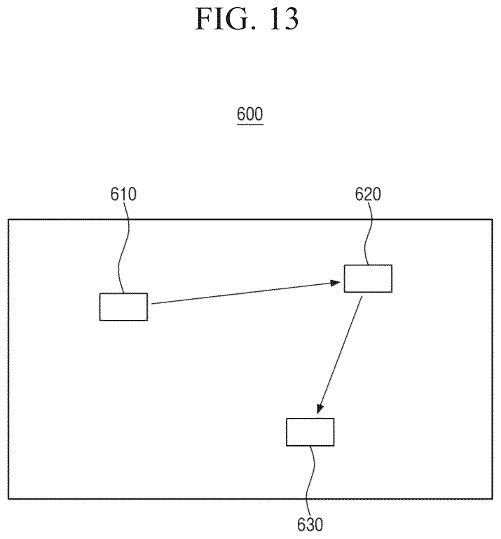

FIG. 13 is a diagram illustrating that a region of interest is switched according to an embodiment of the disclosure.

Referring to FIG. 13, the map analysis unit 160 may detect a standard object from captured images of preset areas of interest 610, 620, and 630 among a capturable area 600 of the imaging unit 110, and may update the absolute distance generated in advance for the depth map of a corresponding captured image (e.g., previously captured image for which the depth map has been generated) based on the detected standard object.

As described above, the map analysis unit 160 may obtain the absolute distance for the entire area of the depth map based on the standard object detected from the captured image 200. Meanwhile, the standard object selected by the map analysis unit 160 may be an object that does not have a standard shape and size. In such cases, an error may be reflected in the absolute distance generated based on the corresponding standard object.

In order to compensate for the reflection of the error due to the selection of the standard object, the map analysis unit 160 may update the absolute distance for the entire area of the previously generated depth map (hereinafter, referred to as an entire absolute distance).

In order to update the entire absolute distance, the map analysis unit 160 may detect the standard object from a captured image of the preset areas of interest 610, 620, and 630 of the capturable area 600 of the imaging unit 110. Here, the capturable area 600 represents a capturing area of the imaging unit 110 determined by a driving range of the pan tilt equipment equipped in the imaging unit 110.

The map analysis unit 160 may extract a standard map object from captured images corresponding to the areas of interest 610, 620, and 630 and obtain an absolute distance for the extracted standard map object. In addition, the map analysis unit 160 may update the entire absolute distance by applying the absolute distance obtained for the standard map object to the entire area of the depth map. In this case, when a difference between the newly generated entire absolute distance and the existing entire absolute distance exceeds a preset threshold value, the map analysis unit 160 may update the entire absolute distance to the newly generated entire absolute distance. The update of the entire absolute distance may be continuously performed, and the reliability of the entire absolute distance for the captured images corresponding to the areas of interest 610, 620, and 630 may be improved by updating the entire absolute distance in this way.

The capturable area 600 of the imaging unit 110 may include the plurality of areas of interest 610, 620, and 630. As illustrated in FIG. 13, the plurality of areas of interest 610, 620, and 630 may be switched in a preset order. The areas of interest 610, 620, and 630 may be areas of the captured image 200 that need to be specifically observed, and the user may pre-set coordinates, switching times, and/or switching orders of the plurality of areas of interest 610, 620, and 630. FIG. 13 illustrates that the areas of interest 610, 620, and 630 are switched in the order of a first area of interest 610, a second area of interest 620, and a third area of interest 630, as an example.

The map analysis unit 160 may detect a standard object from captured images of the areas of interest 610, 620, and 630 that have been switched in a preset order among the plurality of areas of interest 610, 620, and 630. When a reference object is included in the captured images of the switched areas of interest 610, 620, and 630, the map analysis unit 160 may select the standard object among the reference objects. On the other hand, when the reference object is not included in the captured images of the switched areas of interest 610, 620, and 630, the map analysis unit 160 may omit the updating of the entire absolute distance based on the corresponding areas of interest 610, 620, and 630. Referring to FIG. 13, when the reference object is included in the captured image of the first area of interest 610, the map analysis unit 160 may perform the updating of the entire absolute distance for a corresponding captured image. Next, the object detection unit 140 may attempt to detect a reference object from the captured image of the second area of interest 620. As a result, when the reference object is detected from the captured image of the second area of interest 620, the map analysis unit 160 may perform the updating of the entire absolute distance for the captured image. On the other hand, when the reference object is not detected from the captured image of the second area of interest 620, the map analysis unit 160 may omit the updating of the entire absolute distance for the corresponding captured image. Next, the object detection unit 140 may attempt to detect a reference object from the captured image of the third area of interest 630, and such a process may be performed for all areas of interest 610, 620, and 630.

The apparatus and the method for image analysis according to an example embodiment of the disclosure as described above may obtain the absolute distance for the entirety of the depth map by obtaining the absolute distance of the standard map object, which has a correlation between the size and the absolute distance among the map objects included in the depth map, and applying the obtained absolute distance to the remaining portion of the depth map.

Further, the disclosure may be implemented solely in software without separate hardware operation, and thus, the process of obtaining the absolute distance for the entirety of the depth map may be relatively quickly performed.

At least one of the components, elements, modules or units (collectively “components” in this paragraph) represented by a block in the drawings, may be embodied as various numbers of hardware, software and/or firmware structures that execute respective functions described above, according to an example embodiment. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

The effects of the disclosure are not limited to the effects mentioned above, and other effects not mentioned will be clearly understood by those skilled in the art from the description of the claims.

Although example embodiments of the disclosure have been described with reference to the accompanying drawings, those of ordinary skill in the art to which the disclosure pertains will understand that the disclosure may be embodied in other specific forms without changing the technical spirit or essential features thereof. Therefore, it should be understood that the example embodiments described above are illustrative in all aspects and not restrictive.

What is claimed is:

1. An apparatus for image analysis, the apparatus comprising:
at least one memory configured to store program code; and
at least one processor configured to execute the program code to implement:
an imaging unit configured to generate a captured image;
an object detection unit configured to detect at least one object from the captured image;
a depth map generation unit configured to generate a depth map for the captured image; and
a map analysis unit configured to obtain an absolute distance of each pixel for an entire area of the depth map by selecting a standard object among the detected at least one object and referring to an absolute distance obtained for a standard map object corresponding to the standard object among map objects included in the depth map.

2. The apparatus of claim 1, wherein the depth map includes information of a relative distance of the at least one object included in the captured image.

3. The apparatus of claim 1, wherein the object detection unit is configured to, in detecting the at least one object, detect at least one reference object for which standard size information is secured among the at least one object included in the captured image, and
wherein the map analysis unit is configured to select the standard object among the detected at least one reference object.

4. The apparatus of claim 1, wherein the standard map object includes at least two standard map objects, and
wherein the map analysis unit includes:
a distance obtaining unit configured to obtain an absolute distance of each of the at least two standard map objects by referring to a size of each of the at least two standard map objects; and
a distance conversion unit configured to convert a relative distance of each pixel for the entire area of the depth map into an absolute distance according to a ratio between a relative distance and the absolute distance of each of the at least two standard map objects.

5. The apparatus of claim 4, wherein the distance obtaining unit is configured to obtain the absolute distance of each of the at least two standard map objects by referring to a size of a standard area included in a preset portion of each of the at least two standard map objects.

6. The apparatus of claim 5, wherein the distance obtaining unit is configured to obtain the relative distance of each of the at least two standard map objects by extracting relative distance information of two or more pixels included in the standard area.

7. The apparatus of claim 6, wherein the distance obtaining unit is configured to:
generate a feature area of a preset size in the standard area; and
determine an average value or a median value of relative distances of the two or more pixels included in the feature area as the relative distance of each of the at least two standard map objects.

8. The apparatus of claim 1, wherein the map analysis unit is configured to:
detect a standard object from a captured image for a pre-set area of interest of a capturable area of the imaging unit; and
update an absolute distance previously obtained for a depth map of a previously captured image, based on the detected standard object. cm 9. The apparatus of claim 8, wherein the capturable area includes a plurality of areas of interest, and
wherein the map analysis unit is configured to detect a standard object from a captured image for an area of interest, which is selected in a preset order among the plurality of areas of interest.

10. The apparatus of claim 1, wherein the object detection unit is configured to detect the at least one object in real time from the captured image, and
wherein the map analysis unit is configured to, based on detecting the at least one object in real time, obtain the absolute distance of each pixel for the entire area of the depth map.

11. A method for image analysis, the method being executed by at least one processor and comprising:
generating a captured image;
detecting at least one object from the captured image;
generating a depth map for the captured image;
selecting a standard object among the detected at least one object; and
obtaining an absolute distance of each pixel for an entire area of the depth map by referring to an absolute distance obtained for a standard map object corresponding to the standard object among map objects included in the depth map.

12. The method of claim 11, wherein the depth map includes information of a relative distance of the at least one object included in the captured image.

13. The method of claim 11, wherein the detecting the at least one object includes detecting at least one reference object for which standard size information is secured among the at least one object included in the captured image, and
wherein the selecting the standard object includes selecting the standard object among the detected at least one reference object.

14. The method of claim 11, wherein the standard map object includes at least two standard map objects, and,
wherein the obtaining the absolute distance of each pixel for the entire area of the depth map includes:
obtaining an absolute distance of each of the at least two standard map objects by referring to a size of each of the at least two standard map objects; and
converting a relative distance of each pixel for the entire area of the depth map into an absolute distance according to a ratio between a relative distance and the absolute distance of each of at least two standard map objects.

15. The method of claim 14, wherein the obtaining the absolute distance of each of the at least two standard map objects includes obtaining the absolute distance of each of the at least two standard map objects by referring to a size of a standard area included in a preset portion of each of the at least two standard map objects.

16. The method of claim 15, further comprising obtaining a relative distance of each of the at least two standard map objects by extracting relative distance information of two or more pixels included in the standard area.

17. The method of claim 16, wherein the obtaining the relative distance of each of the at least two standard map objects includes:
generating a feature area of a preset size in the standard area; and
determining an average value or a median value of relative distances of the two or more pixels included in the feature area as the relative distance of each of the at least two standard map objects.

18. The method of claim 11, further comprising:
detecting a standard object from a captured image for a pre-set area of interest of a capturable area of an imaging unit configured to generate the captured image; and
updating an absolute distance previously obtained for a depth map of a previously captured image, based on the detected standard object.

19. The method of claim 18, wherein the capturable area includes a plurality of areas of interest, and
wherein the detecting the standard object includes detecting the standard object from a captured image for an area of interest, which is selected in a preset order among the plurality of areas of interest.

20. The method of claim 11, wherein the detecting the at least one object includes detecting the at least one object in real time from the captured image, and
wherein the obtaining the absolute distance of each pixel for the entire area of the depth map includes obtaining the absolute distance of each pixel for the entire area of the depth map, based on detecting the at least one object in real time.
